(19) United States
(12) Patent Application Publication
(10) Pub. No.: US 2024/0308434 A1
(43) Pub. Date: Sep. 19, 2024

(54) SENSOR MODULE FOR BEING DISPOSED ON A PANEL COMPONENT OF A MOTOR VEHICLE AND ROOF MODULE FOR FORMING A VEHICLE ROOF ON A MOTOR VEHICLE

(71) Applicant: Webasto SE, Stockdorf (DE)

(72) Inventors: Bernhard SCHIEDER, Stockdorf (DE); Thomas PODOLSKI, Stockdorf (DE)

(21) Appl. No.: 18/599,685

(22) Filed: Mar. 8, 2024

(30) Foreign Application Priority Data
Mar. 14, 2023 (DE) 10 2023 106 330.8

(51) Int. Cl. B60R 11/00; B62D 25/06; G01S 17/931; G02B 5/28

(52) U.S. Cl. CPC B60R 11/00; B62D 25/06; G01S 17/931; G02B 5/281; B60R 2011/004

(57) ABSTRACT

A sensor module for being disposed on a panel component of a motor vehicle comprises a cover, which forms at least areas of an outer skin of the sensor module and has a viewing area, and at least one environment sensor, which is configured for transmitting and/or receiving electromagnetic signals via the viewing area in order to thus chart the vehicle environment. At least areas of the cover comprise a multifunctional film, which has a heating function in the viewing area and has an infrared protective function in at least one area of the cover different to the viewing area.

### CROSS-REFERENCE TO RELATED APPLICATION

This application claims the benefit of German patent application no. 10 2023 106 330.8, filed Mar. 14, 2023, which is incorporated herein by reference in its entirety.

### TECHNICAL FIELD

The invention relates to a sensor module for being disposed on a panel component of a motor vehicle, the sensor module comprising a cover, which forms at least areas of an outer skin of the sensor module and has a viewing area, and at least one environment sensor, which is configured for transmitting and/or receiving electromagnetic signals via the viewing area in order to thus chart the vehicle environment. The invention further relates to a roof module for forming a vehicle roof on a motor vehicle, the roof module comprising a panel component, which forms at least areas of a roof skin of the motor vehicle, the roof skin acting as an outer sealing surface, the panel component comprising a cover, which has a viewing area, and at least one environment sensor, which is con-figured for transmitting and/or receiving electromagnetic signals via the viewing area in order to thus chart a vehicle environment.

### BACKGROUND

Generic sensor modules are known from the state of the art and are already used in vehicle construction. Sensor modules of this kind are used, for example, to monitor a parking process, with ultrasonic sensors normally being used as environment sensors.

Sensor modules of this kind often comprise a sensor casing and an environment sensor which is disposed at least partially in the sensor casing and which is configured for transmitting and/or receiving electromagnetic signals in order to thus chart a vehicle environment, for example during a parking maneuver. The known sensor modules can be rigidly disposed on a panel component (a body part of the motor vehicle). Alternatively, it is known to dispose sensor modules of this kind so as to be retractable and extendable in relation to the panel component. This means that the sensor module can be retracted when not required and does not pose an acoustic and/or aerodynamic disturbance.

Furthermore, the development in vehicle manufacturing is increasingly focusing on autonomously and semi-autonomously driving motor vehicles. In order to enable the vehicle controller to control the motor vehicle autonomously or semi-autonomously, a plurality of environment sensors (e.g., lidar sensors, radar sensors, (multi-)cameras, etc. including other (electrical) components) are employed, which are integrated in the roof module, for example, and which chart the environment surrounding the motor vehicle and determine, for example, a current traffic situation from the acquired environment data. Roof modules which are equipped with a plurality of environment sensors are also known as roof sensor modules (RSM). For this purpose, the known environment sensors transmit and/or receive suitable electromagnetic signals, such as laser beams or radar beams, allowing a data model of the vehicle environment to be generated by suitable signal evaluation and to be used for controlling the vehicle. These environment sensors for monitoring and charting the vehicle environment are usually attached to the vehicle roof, as the vehicle roof is usually the highest point of a vehicle from which the vehicle environment can be easily seen.

Generic roof modules are prefabricated as separate functional modules and can be delivered to the assembly line when assembling the vehicle. The roof module at least partially forms a roof skin of the vehicle roof, the roof skin preventing moisture and air flows from entering the vehicle interior. The roof skin is composed of one or more panel components, which can be made of a stable material, such as painted metal or painted or solid-colored plastic. The roof module can be a part of a fixed vehicle roof or a part of an openable roof sub-assembly.

The known sensor modules or roof modules, which have at least one environment sensor, comprise at least one viewing area, which is made of a material which is trans-parent for the specific wavelength range of the environment sensor in use. Known viewing areas can, for example, ensure undisturbed signal transmission, but alternatively also have optical filter properties or the properties of a lens, for example to enlarge the field of view. The environment sensor is disposed opposite the viewing area in such a manner that it can transmit and/or receive electromagnetic signals via the viewing area in order to thus chart the vehicle environment with the aid of suitable signal processing. A viewing area of this kind can be provided, for example, in a wall of a sensor casingcas-ing of a sensor module or in the panel component or a cover of a roof module. In this context, the viewing area is recessed, for example, as a window in the sensor casing or the panel component.

New design requirements and/or associated technical advantages increasingly demand that panel components and/or covers of sensor modules are made in one piece. This avoids, for example, sealing problems compared to segmented panel components and/or covers. On the other hand, the result gives a visually rounded appearance, which is advantageous for customer appeal. For example, entire roof modules and/or panel components and/or sensor modules and/or covers are manufactured from one material. To enable the environment sensor to function via the one-piece component in question, it must be made from a sensor-transparent material. For example, when using lidar sensors, there are black materials made of polycarbonate that are transparent to the wavelengths of the lidar, yet opaque to the human eye. This allows the lidar sensor to be integrated under a protective cover through which one cannot look. If cameras are used, such black or invisible materials cannot be used, as the camera operates in the same or at least a similar wavelength range as the human eye.

In order to enable the environment sensor to function without interruption, even in adverse weather conditions such as snow, ice and/or fog, it is necessary to keep the viewing area as free as possible from snow and/or ice and/or fog and/or moisture (and also from other dirt). For this purpose, known sensor modules and/or roof modules often have de-icing devices, for example in the form of heating foils, which are disposed on the viewing area, in addition to cleaning devices, which will not be discussed in detail here. These heating applications are often applied to a support film, which can then be injected in the plastic component of the roof module and/or the panel component and/or the cover.

Although a selection of materials which appear opaque to the human eye is available for at least some sensor types, such materials pose the problem that they are not only transparent to the wavelengths used by the environment sensor. These materials are also permeable to infrared radiation from the sun. If the sensor module and/or the roof module are positioned so as to be exposed on a roof of the vehicle, this means that an internal sensor system is exposed to strong heat radiation. This can result in a temperature operating range of a relevant environment sensor being exceeded, at least temporarily. This restricts or even disrupts a functionality of the relevant environment sensor.

As a solution to this problem, it seems possible to block the passage of IR heat radiation by using an additional plastic component which is not IR-transparent and is sprayed onto the back. However, such a design approach is associated with an increased material thickness, which in turn results in a higher component weight. In addition, an increase in material thickness is likely to have an impact on other interfaces, on the installation space concept in a vehicle height direction and on the CO2 balance of the overall vehicle. Such an approach is therefore disadvantageous.

### SUMMARY

One object of the invention is to propose an improved sensor module and/or an improved roof module which can at least partially overcome the disadvantages of the state of the art.

The object is attained by a sensor module having the features that at least areas of the cover comprise a multifunctional film, which has a heating function in the viewing area and has an infrared protective function in at least one area of the cover different to the viewing area. Furthermore, the object is attained by a roof module having the features that at least areas of the cover comprise a multifunctional film, which has a heating function in the viewing area and which has an infrared protective function in at least one area of the cover different to the viewing area.

Advantageous embodiments of the invention are the subject matter of the dependent claims. Moreover, any and all combinations of at least two features disclosed in the description, the claims, and/or the figures fall within the scope of the invention. Naturally, the explanations given in connection with the sensor module and/or the roof module equivalently relate to the motor vehicle according to the invention, without being mentioned separately in its context. In particular, linguistically common rephrasing and/or an analogous replacement of respective terms within the scope of common linguistic practice, in particular the use of synonyms backed by the generally recognized linguistic literature, are of course comprised by the content of the disclosure at hand without every variation having to be expressly mentioned.

In its intended use, the sensor module according to the invention is designed to be disposed on a panel component (which, for example, forms part of a vehicle body) of a motor vehicle. The sensor module comprises a cover, which forms at least areas and/or sections of an outer skin of the sensor module, and has a viewing area. Furthermore, the sensor module comprises at least one environment sensor, which is configured for transmitting and/or receiving electromagnetic signals via the viewing area in order to thus chart the vehicle environment. At least areas of the cover comprise a multifunction-al film, which has a heating function in the viewing area and has an infrared protective function in at least one area of the cover different to the viewing area.

In its intended use, the roof module according to the invention is designed to form at least areas of a vehicle roof of a motor vehicle. The roof module comprises a panel component, which forms at least areas of a roof skin of the motor vehicle, the roof skin acting as an outer sealing surface. The panel component comprises a cover, which has a viewing area. The roof module comprises at least one environment sensor, which is configured for transmitting and/or receiving electromagnetic signals via the viewing area in order to thus chart a vehicle environment. At least areas of the cover comprise a multifunctional film, which has a heating function in the viewing area and which has an infrared protective function in at least one area of the cover different to the viewing area.

According to the invention, therefore, a multifunctional film is used which is provided with a heating function in at least one partial area of the cover, namely at least in the viewing area, and which is provided with an infrared protective function in at least one other partial area of the cover, which is preferably different to the viewing area and/or is spaced apart therefrom and/or is adjacent thereto. The multifunctional film is preferably applied to the cover in a single process step. In an applied state, at least areas of the multifunctional film preferably extend over the viewing area and beyond into other sections of the cover which are exposed to solar radiation when the sensor module and/or the roof module are used as intended. The multifunctional film is preferably molded onto and/or in the cover.

By using the multifunctional film, it is possible to manufacture the outer skin of the cover from only an IR-transparent material, which is preferably transparent for the environment sensor and non-transparent for the human eye. Nevertheless, an IR protection function can be provided in at least one area outside the viewing area, allowing an operating temperature range of the environment sensor to be maintained. Furthermore, the de-icing function and/or the heating function can be provided in the area of the viewing area so the environment sensor does not fail due to weather conditions. The heating function and the infrared protective function can be provided via an individual shared multifunctional film. The multifunctional film can, for example, be prefabricated by the meter and be provided on the production line of the cover. The multifunctional film thus makes it possible to combine several functions necessary for the uninterrupted use of the environment sensor in an individual film. Since a heating film is preferred at any rate for uninterrupted operation of the environment sensor, the combination of the two functional layers on the shared multifunctional film replaces the application of a separate IR reflective film and a separate heating film compared to the state of the art.

The phrase “at least one” is to be understood as meaning that one or more of the respective components mentioned in this context may be included according to the invention. For example, the sensor module and/or the roof module may comprise one or more environment sensors, i.e. at least one environment sensor.

The sensor module can preferably comprise a sensor casing or at least a casing part. The sensor casing or the casing part can preferably be designed in such a manner that it completely accommodates the environment sensor, preferably completely enclosing it and/or preferably forming a dry area in its interior in which the environment sensor is protected from moisture. The sensor casing can also only partially enclose the environment sensor. The sensor casing can also comprise several environment sensors which, for example, have different functions and/or orientations. The sensor casing can preferably be disposed on the cover. The cover can also form at least a part of a sensor casing of this kind.

The term “viewing area” preferably refers to a window and/or a lens through which the at least one environment sensor looks in order to chart the vehicle environment. The viewing area can preferably be made of a particularly shatterproof and/or shatter-resistant plastic, for example a polycarbonate, or glass.

The roof module according to the invention can form a structural unit in which installations for autonomous or semi-autonomous driving supported by driver assistance systems are integrated and which can be mounted as a unit on a vehicle body shell by a vehicle manufacturer. Furthermore, the roof module according to the invention can be designed as a purely fixed roof or as a roof including a roof opening system. In addition, the roof module can be designed for use in a passenger car or in a commercial vehicle. The roof module can preferably be provided as a structural unit in the form of a roof sensor module (RSM), in which the environment sensors are provided in order to be inserted as a deliverable structural unit in a roof frame of a vehicle body.

In a preferred embodiment, the cover is made in one piece. As a result, visually unattractive separations, e.g., between the viewing area and the remaining and/or surrounding cover, can be avoided. Likewise, no seals and/or joints need to be provided, which significantly simplifies the manufacturing process.

In a preferred embodiment, the cover is made of a material transparent for the electromagnetic signals of the at least one environment sensor. The cover is therefore generally also transparent for IR radiation. However, in areas where the environment sensor does not need to be transparent, the multifunctional film blocks the IR radiation via the IR protection layer and thus prevents it from penetrating the interior of the sensor module and/or the roof module.

In a preferred embodiment, the multifunctional film has at least one heating layer and/or a heating coat for providing the heating function. Alternatively or additionally, the multifunctional film has an infrared protective layer and/or an infrared protective coat for providing the infrared protective function. The respective layer and/or coat can, for example, be printed and/or vapor-deposited and/or applied in some other manner. Particularly preferred, the heating layer and/or the heating coating and/or the infrared protective layer and/or the infrared protective coating is applied and/or printed and/or vapor-deposited on a support film. For example, a screen printing process can also be used. Alternatively or additionally, the heating layer and/or the heating coating and/or the infrared protective layer and/or the infrared protective coating can be applied and/or laminated on the support film, in particular as respective film segments.

In a preferred embodiment, the multifunctional film is divided in at least two function segments, one function segment providing the heating function and the other function segment providing the infrared protective function. The multifunctional film can of course also be divided in more functional segments, each of which can comprise different functions and/or can also partly comprise the same functions. For example, a multifunctional film can comprise several segments, each of which provides a heating function, for example if the cover comprises several viewing areas for several environment sensors and/or for a movable environment sensor.

In a preferred embodiment, the multifunctional film is at least partially injected and/or laminated in the cover. In this context, the multifunctional film can preferably be embedded in the surrounding cover so that the multifunctional film does not protrude and/or protrudes only slightly, for example a few micrometers or millimeters, beyond the surrounding cover. Particularly preferably, the multifunctional film is flush with the surrounding and/or encircling cover.

In a preferred embodiment, at least areas of the multifunctional film has a non-stick function and/or an anti-mist function. Other functional coats are also conceivable.

In a preferred embodiment, the multifunctional film is disposed on an inner side of the cover opposite the outer skin.

In a preferred embodiment, the sensor module and/or roof module according to the invention comprises a lidar sensor and/or a radar sensor and/or a camera sensor and/or an ultrasonic sensor and/or a multi-camera sensor. Lidar sensors operate, for example, in a wavelength range of 905 nm or even around 1,550 nm. The sensor module preferably comprises a viewing area through which the environment sensor looks in order to chart a vehicle environment. The material of the viewing area is preferably transparent for the wavelength range used by the environment sensor and is selected on the material side depending on the wavelength(s) used by the environment sensor. In principle, other environment sensors not mentioned here can also be used.

The invention also relates to a motor vehicle having a panel component and at least one sensor module according to the invention. The sensor module can be rigidly disposed on the panel component or be disposed so as to be extractable and retractable in an opening of the panel component. Particularly preferably, the panel component on which the sensor module according to the invention is disposed is at least part of a roof skin, a mudguard, a bumper, an outer trim component of a sunroof, a window, a door, a sliding roof, a soft top, a folding roof, a hood or a trunk lid. In principle, other panel components of a motor vehicle not mentioned here are also included in the invention. It is understood that a motor vehicle can also comprise several of the aforementioned panel components, each of which can preferably comprise at least one sensor module according to the invention.

The invention also relates to a motor vehicle having a roof frame structure and a roof module according to the invention, which is mounted as a structural unit on the roof frame structure.

Of course, the embodiments and the exemplary embodiments mentioned above and yet to be discussed below can be realized not only individually but also in any combination with each other without departing from the scope of the present invention. Moreover, any and all embodiments and exemplary embodiments of the sensor module also relate in their entirety to the roof module and to a motor vehicle comprising a sensor module and/or a roof module.

### BRIEF DESCRIPTION OF DRAWINGS

Embodiments of the invention are shown schematically in the drawings and are explained below by manner of example.

FIG. 1 shows a schematic view of a motor vehicle having a roof module;

FIG. 2 shows a schematic view of a motor vehicle having a panel component forming a roof skin, an exemplary embodiment of a sensor module ac-cording to the invention being disposed on the panel component;

FIG. 3 shows a schematic view of a sensor module;

FIG. 4 shows another schematic view of a sensor module;

FIG. 5 shows a schematic view of a sensor module from below;

FIG. 6 shows a schematic detailed view of a sensor module;

FIG. 7 shows another schematic detailed view of a sensor module;

FIG. 8 shows a schematic view of a cover;

FIG. 9 shows another schematic detailed view of a sensor module;

FIG. 10 shows a sectional view of a sensor module in a first embodiment; and

FIG. 11 shows a sectional view of a sensor module in a second embodiment.

### DETAILED DESCRIPTION

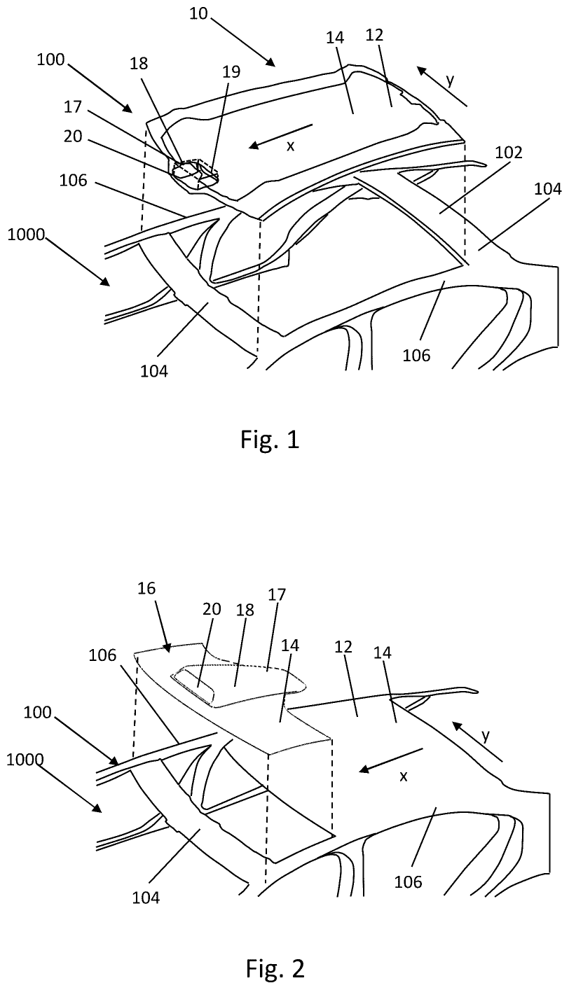

FIG. 1 describes an exemplary embodiment of a first aspect of the invention.

FIG. 1 shows a motor vehicle 1000 having a vehicle roof 100. The vehicle roof 100 is designed as a roof module 10. The roof module 10 comprises a panel component 12, which forms a roof skin 14 of the motor vehicle 1000. The roof module 10 is mounted on a roof frame structure 102 of the motor vehicle body, which is indicated by dashed lines. An environment sensor 18 is disposed below the panel component 12 in a frontal, central roof area of the panel component 12, viewed in a longitudinal vehicle direction x. The longitudinal vehicle direction x is transverse, preferably orthogonal to a transverse vehicle direction y. Alternatively, the environment sensor 18 can also be disposed so as to extend and retract in an opening of the panel component 12. The environment sensor 18 is disposed directly behind a front transverse beam 104, which defines a roof header of the vehicle. Together with the rear transverse beam 104 and two side beams 106, the front transverse beam 104 forms the roof frame structure 102. The environment sensor 18 is covered by the panel component 12. The panel component 12 forms a cover 17 of the environment sensor 18.

The environment sensor 18 can be a lidar sensor, for example. Other sensor types, e.g. (multidirectional) cameras and/or ultrasonic sensors, can also be used. Furthermore, the environment sensor 18 comprises a sensor casing 19 in which the environment sensor 18 is at least partially disposed. The sensor casing 19 can also be a partial casing and/or a casing section. The environment sensor 18 is configured to transmit and/or receive electromagnetic signals via a viewing area 20 in order to chart a vehicle environment of the motor vehicle 1000 (e.g. for autonomous driving or for parking). In the present case, the viewing area 20 is provided integrally in the panel component 12 forming the cover 17.

FIG. 2 describes an exemplary embodiment of a second aspect of the invention.

FIG. 2 shows the motor vehicle 1000 having the vehicle roof 100 in another embodiment. According to this embodiment, at least some areas of the vehicle roof 100, in this case a frontal area, are formed by a sensor module 16 which is disposed as a structural unit on the roof frame structure 102, in this case on the frontal transverse beam 104 and in each case on a part of the side beams 106 of the motor vehicle body and/or the surrounding panel component, which is indicated in the form of dashed lines. The sensor module 16 comprises the cover 17 for forming at least areas of an outer skin, in this case the roof skin 14, of the vehicle roof 100.

As shown in FIG. 2, the sensor module 16 is disposed in the frontal roof area of the motor vehicle 1000, viewed in the longitudinal vehicle direction x. The sensor module 16 comprises the environment sensor 18, which is covered by the cover 17 as shown in FIG. 2. The environment sensor 18 is therefore disposed below the cover 17, for example on a roof module frame (not shown in detail). The environment sensor 18 charts the vehicle environment via the viewing area 20, which in this case is integrally formed in the cover 17.

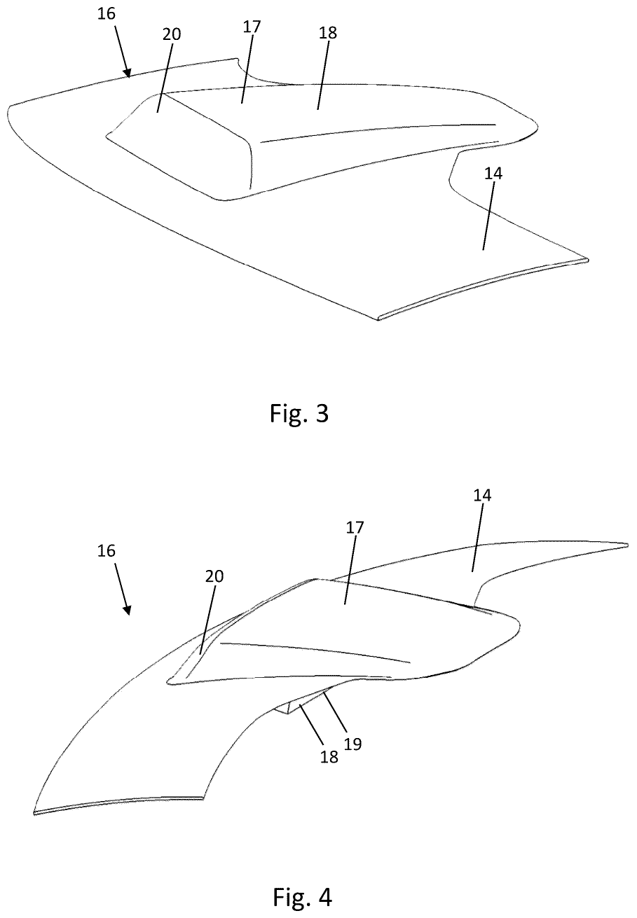

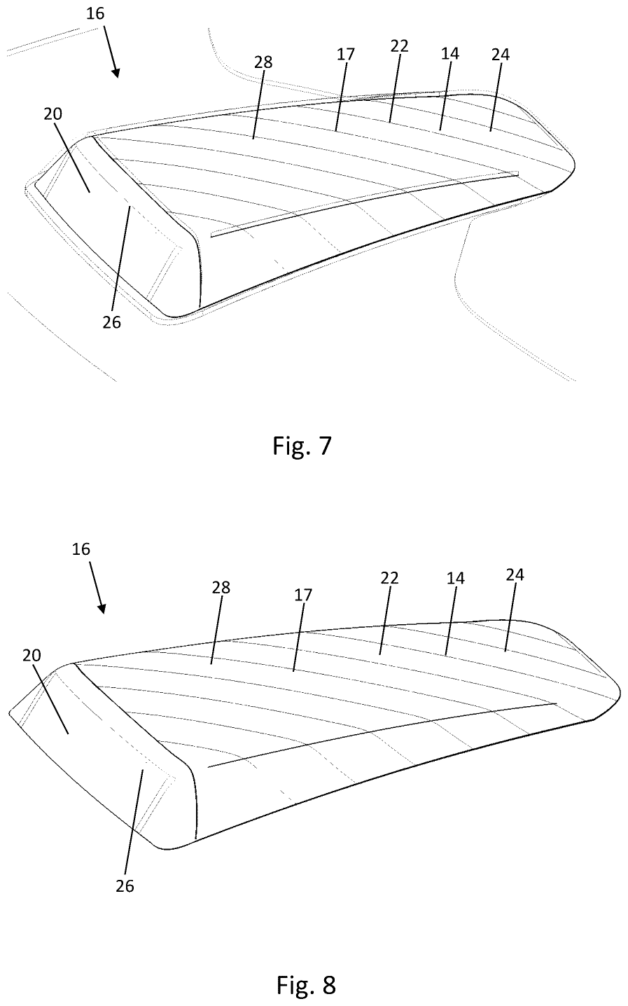

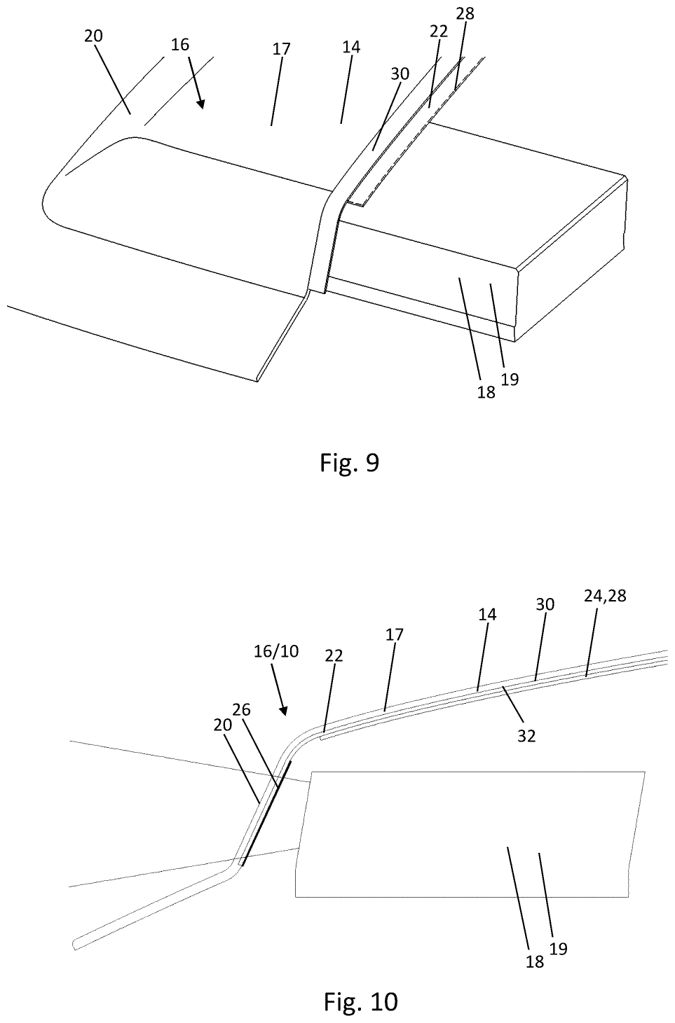

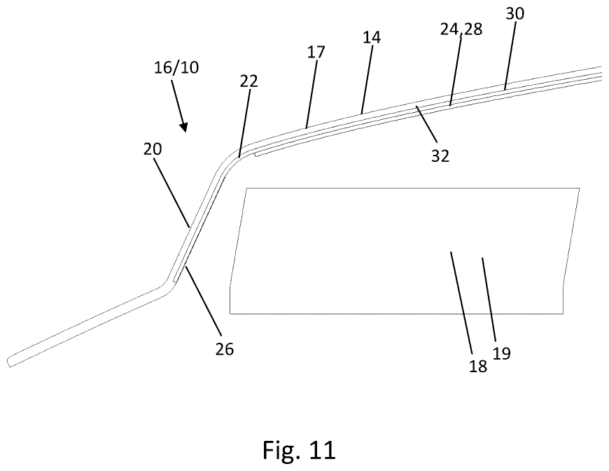

The sensor module 16 is shown in more detail in FIGS. 3 to 11. However, the explanations also refer in analogous form to the roof module 10 according to the invention, without being explicitly mentioned again for this embodiment. FIGS. 10 and 11 in particular can be a sectional view of the roof module 10 in the same manner.

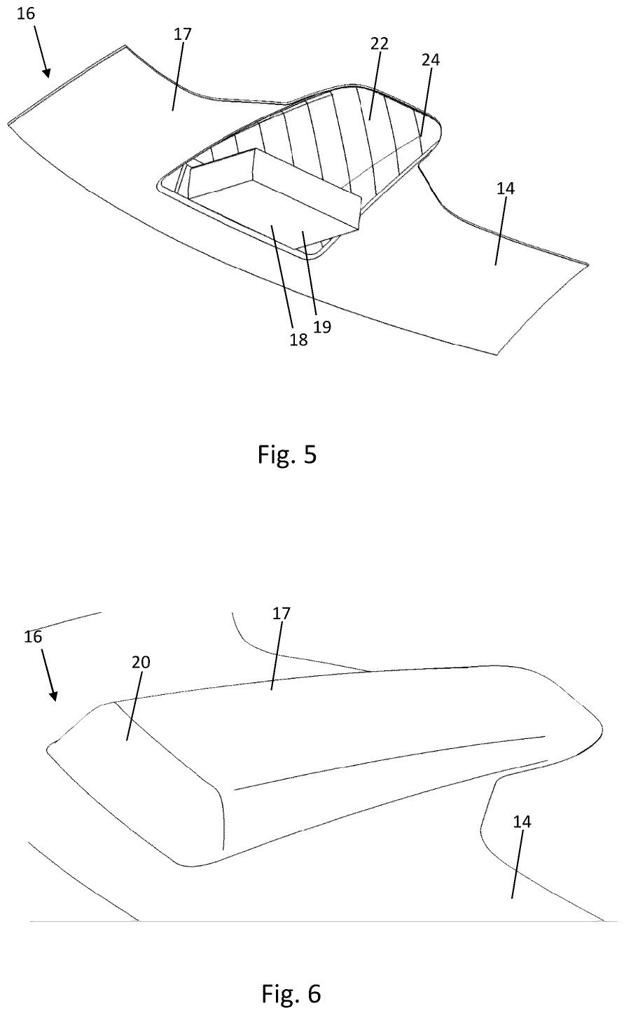

According to the invention, at least areas of the cover 17 comprise a multifunctional film 22. Particularly preferably, the cover 17 comprises a formed, in particular coated multifunctional film 22. The multifunctional film 22 has a heating function in the viewing area 20 and an infrared protective function in at least one area 24 of the cover 17 different to the viewing area 20 and shown as a dashed line in FIGS. 5, 7 and 8. The cover 17 is made of a material, for example polycarbonate, which is transparent to the electromagnetic signals of the at least one environment sensor 18.

The multifunctional film 22 has at least one heating layer 26 and/or a heating coating to provide the heating function. Furthermore, the multifunctional film 22 has an infrared protective layer 28 and/or an infrared protective coating to provide the infrared protective function. The heating layer 26 and the infrared protective layer 28 are applied and/or printed and/or vapor-deposited on a support film 30, as can be seen in particular from the sectional views in FIGS. 10 and 11. In the case of FIG. 10, the heating layer 26 is printed on the support film 30 in the area of the viewing area 20. The infrared protective layer 28, on the other hand, is laminated on the support film 30 as an infrared protective coating in the form of an extra film. In the case of FIG. 11, the heating layer 26 is vapor-deposited on the support film 30 in the area of the viewing area 20. The infrared protective layer 28 is laminated on the support film 30 as an infrared protective coating in the form of a film section and/or a film segment. The infrared protective layer 28 can, for example, also be a lacquered layer having an increased silver content. The infrared protective layer 28 can also comprise a material having similarly good reflective properties (compared to silver). The infrared protective layer 28 and/or reflective layer can also be vapor-deposited or screen-printed. This preferably includes all functional materials and/or application methods, regardless of the respective layer thickness.

The multifunctional film 22 is at least partially injected and/or laminated in the cover 17, as can be seen in FIGS. 10 and 11. In doing so, the multifunctional film 22 is disposed on an inner side 32 of the cover 17 opposite the outer skin.

### LIST OF REFERENCE NUMERALS

10 roof module
12 panel component
13 second panel component
14 roof skin
16 sensor module
17 cover
18 environment sensor
19 sensor casing
20 viewing area
22 multifunctional film
24 area
26 heating layer
28 infrared protective layer
30 support film
32 inner side
100 vehicle roof
102 roof frame structure
104 transverse beam
106 longitudinal beam
1000 motor vehicle
x longitudinal vehicle direction
y transverse vehicle direction

1. A sensor module for being disposed on a panel component of a motor vehicle, the sensor module comprising a cover, which forms at least areas of an outer skin of the sensor module and has a viewing area, and at least one environment sensor, which is configured for transmitting and/or receiving electromagnetic signals via the viewing area in order to thus chart the vehicle environment, wherein at least areas of the cover comprise a multifunctional film, which has a heating function in the viewing area and has an infrared protective function in at least one area of the cover different to the viewing area.

2. The sensor module according to claim 1, wherein the cover is made in one piece.

3. The sensor module according to claim 1, wherein the cover is made of a material transparent for the electromagnetic signals of the at least one environment sensor.

4. The sensor module according to claim 1, wherein the multifunctional film has at least one heating layer and/or a heating coat for providing the heating function, and/or the multifunctional film has an infrared protective layer and/or an infrared protective coat for providing the infrared protective function.

5. The sensor module according to claim 4, wherein the heating layer and/or the heating coat and/or the infrared protective layer and/or the infrared protective coat is applied and/or printed and/or vapor-deposited on a support film, and/or the heating layer and/or the heating coat and/or the infra-red protective layer and/or the infrared protective coat is applied and/or laminated on the support film in particular as film segments.

6. The sensor according to claim 1, wherein the multifunctional film is divided in at least two function segments, one function segment providing the heating function and the other function segment providing the infrared protective function.

7. The sensor module according to claim 1, wherein the multifunctional film is at least partially injected and/or laminated in the cover.

8. The sensor module according to claim 1, wherein at least areas of the multifunctional film has a non-stick function and/or an anti-mist function.

9. The sensor module according to claim 1, wherein the multifunctional film is disposed on an inner side of the cover opposite the outer skin.

10. The sensor module according to claim 1, wherein the at least one environment sensor comprises a lidar sensor and/or a radar sensor and/or a camera sensor and/or an ultrasonic sensor and/or a multi-camera sensor.

11. A motor vehicle or roof module having a panel component and at least one sensor module according to claim 1, the sensor module being rigidly disposed on the panel component or disposed so as to be extractable and retractable in an opening of the panel component, and the cover forming at least areas of an outer skin of the motor vehicle.

12. The roof module for forming a vehicle roof on a motor vehicle, the roof module comprising a panel component, which forms at least areas of a roof skin of the motor vehicle, the roof skin acting as an outer sealing surface, the panel component comprising a cover, which has a viewing area, and at least one environment sensor, which is configured for transmitting and/or receiving electromagnetic signals via the viewing area in order to thus chart a vehicle environment, wherein at least areas of the cover comprise a multifunctional film, which has a heating function in the viewing area and which has an infrared protective function in at least one area of the cover different to the viewing area.

13. The motor vehicle having a roof frame structure and at least one roof module according to claim 12, which is mounted on the roof frame structure as a structural unit.
